(19) United States
(12) Patent Application Publication
(10) Pub. No.: US 2021/0392254 A1
(43) Pub. Date: Dec. 16, 2021

(54) ARRANGEMENT AND METHOD FOR CAPTURING IMAGE OF LOG

(71) Applicant: TRACY OF SWEDEN AB, Virsenum (SE)

(72) Inventors: Per-Erik ANDERSSON, Lund (SE); Giorgios NIKOLERIS, Södra Sandby (SE); Jonny EDVARDSSON, Virsenum (SE); Jan-Erik RENDAHL, Stockholm (SE)

(21) Appl. No.: 17/290,431

(22) PCT Filed: Oct. 31, 2019
(86) PCT No.: PCT/IB2019/059352

§ 371 Date: Apr. 30, 2021

(30) Foreign Application Priority Data
Nov. 3, 2018 (SE) 18303214

(51) Int. Cl. H04N 5/225; G02B 27/00; G03B 17/08; G03B 13/32; H04N 5/235; B08B 3/02; B08B 5/02

(52) U.S. Cl. CPC H04N 5/22521; G02B 27/0006; G03B 17/08; G03B 13/32; A01G 23/099; H04N 5/2355; B08B 3/02; B08B 5/02; H04N 5/2252

(57) ABSTRACT

Disclosed is arrangement (100) for capturing image of a log; arrangement (100) comprising first housing structure (102) comprising at least two end walls (202), (204) and at least one side wall (206), wherein the at least one side wall (206) include at least one opening (210); second holding structure (104) arranged within first housing structure (102) wherein second holding structure (104) holds at least one imaging device (106) for capturing at least one image of planar surface (304) of log (302); first controlling unit (108) attached to first housing structure (102) and operatively coupled to second holding structure (104) for moving second holding structure (104) from first position to second position, wherein at second position at least one imaging device (106) is positioned axially on at least one opening (210); and second controlling unit (110) is operatively coupled to at least one imaging device (106) and is configured to instruct at least one imaging device (106) to capture after positioning axially at least one image of planar surface (304) of log (302).

### TECHNICAL FIELD

The present disclosure relates generally to arrangements and methods for use in timber industries and more specifically to arrangements and methods for capturing images of logs.

### BACKGROUND

Generally, timber industries include operations, such as logging and processing for generating high-demand wooden products. Logging involves cutting trees and turning them into logs. Furthermore, identification of an origin of the log (lumber) in the timber industries has become a critical task for various reasons. For examples, determining the value of the log, determining the legality of use of the log in a given reason, and the like. Conventionally, an imaging device such as camera is used to capture images of the trees and the logs

However, such conventional camera arrangements used for categorization, classification and identification of logs includes a number of problems. One such problem associated with the conventional camera arrangements relates to unclear images used for the identification of logs. The image capture process is limited to a couple of milliseconds because the log is moved out from the harvester directly and fast after a finished cut, and thereby leading to an unclear image. Therefore, rapid cameras which could capture an image between two cuts of the chain saw are required. Furthermore, the cameras of the conventional camera arrangements are constrained by hardware limitations and are thereby mounted at different angles on different harvesters. Consequently, the one or more image generated by differently positioned cameras can be significantly different for the given log. Thus, the results generated by the conventional camera arrangements may be unreliable. Moreover, the perspective camera projection of the cameras of the conventional camera arrangements may distort the images. Such distorted images make it harder to compare two images for a given log taken from different angles. Therefore, conventional camera arrangements may not be efficient for identification of logs. Notably, harvesting is a turbulent process which makes the process of acquiring suitable images difficult. Consequently, identification of logs using the conventional camera arrangements may be inherently defective.

Furthermore, the cameras of the conventional camera arrangements are not robust to withstand severe environmental conditions. For example, the cameras are in direct contact with the ground/earth when the harvester head is operated to cut the tree with its chainsaw and are thereby prone to damages. Additionally, the conventional cameras are also prone to damages when exposed to dust, water, snow, stones, branches, roots and sawdust and thus leading to inefficiency in identification of logs.

Therefore, in light of the foregoing discussion, there exists a need to overcome aforementioned drawbacks associated with the conventional methods of identification of logs.

### SUMMARY

The present disclosure seeks to provide an arrangement for capturing image of a log.

The present disclosure also seeks to provide a method of capturing image of a log using an arrangement.

In one aspect, an embodiment of the present disclosure provides an arrangement for capturing image of a log, the arrangement comprising:
a housing structure comprising at least two end walls and at least one side wall, wherein the at least one side wall include at least one opening;
a holding structure arranged within the housing structure, and wherein the holding structure holds at least one imaging device for capturing at least one image of a planar surface of the log;
a first controlling unit attached to the housing structure and operatively coupled to the holding structure for moving the holding structure from a first position to a second position, wherein at the second position of the holding structure, the at least one imaging device is positioned on an axis of abscissas of the at least one opening of the housing structure; and
a second controlling unit operatively coupled to the at least one imaging device, wherein the second controlling unit is configured to instruct the at least one imaging device to capture the at least one image of the planar surface of the log.

The present disclosure provides an at least partial solution to the aforementioned technical problem, or problems, associated with known art, wherein arrangement for capturing image of a log includes one or more structures to securely hold the at least one imaging device for capturing at least one image of a planar surface of the log.

Optionally, the arrangement further comprises, at least one of a first damping components arranged between the holding structure, and the at least one imaging device, and a dampening structure on the at least one opening of the housing structure.

Optionally, the arrangement further comprises a transparent component snugly arranged on the at least one opening of the housing structure for covering the at least one opening.

Optionally, the arrangement further comprises a power source connected to the at least one imaging device, the first controlling unit and the second controlling unit, for providing operational power thereto.

Optionally, the arrangement further comprises a protective component snugly arranged on the housing structure for providing support therein.

Optionally, the protective component includes at least one opening coaxial to the at least one opening of the housing structure.

Optionally, the arrangement further comprises a second damping component arranged between the protective component and the housing structure.

Optionally, the arrangement further comprises a cleaning unit for cleaning the at least one imaging device.

Optionally, the cleaning unit is configured to spray on the at least one imaging device, at least one of: compressed air, and cleaning liquid.

Optionally, the cleaning unit is a self-cleaning micro filter.

Optionally, the at least one imaging device comprises a plurality of lenses.

Optionally, the plurality of lenses is autofocused to capture the at least one image of the planar surface of the log; or manually focused for capturing the at least one image of the planar surface of the log.

Optionally, the at least one image of the planar surface of the log is a high dynamic range (HDR) image.

Optionally, the housing structure is of rectangular cross-section.

In another aspect, an embodiment of the present disclosure provides a method of capturing image of a log using an arrangement, wherein the arrangement includes a housing structure, a holding structure arranged within the housing structure, a first controlling unit attached to the housing structure for moving the holding structure, at least one imaging device, and a second controlling unit for controlling the at least one imaging device, the method comprising:
moving the holding structure from a first position to a second position, wherein at the second position of the holding structure, the at least one imaging device positions on an axis of abscissas of an at least one opening of the housing structure; and
capturing the at least one image of a planar surface of the log using the at least one imaging device.

Optionally, the method further comprises dampening of vibrations in the arrangement.

Optionally, the method further comprises snugly arranging a transparent component on the at least one opening of the housing structure for covering the at least one opening therein.

Optionally, the method further comprises providing operational power to the at least one imaging device, the first controlling unit and the second controlling unit.

Optionally, the method further comprises cleaning the at least one imaging device using a cleaning unit.

Optionally, the cleaning of the at least one imaging device comprises spraying compressed air and/or cleaning liquid thereon.

Optionally, the method further comprises autofocusing the at least one imaging device to capture the at least one image of the planar surface of the log; or manually focusing the at least one imaging device for capturing the at least one image of the planar surface of the log.

Optionally, the method further comprises capturing a high dynamic range (HDR) image of the at least one image of the planar surface of the log.

The present disclosure provides an arrangement for capturing image of a log and method of capturing image of a log using an arrangement. The arrangement includes a housing structure that houses the holding structure including at least one imaging device. Essentially, arranging the at least one imaging device within the housing structure and the holding structure, provides a secure environment. Furthermore, the housing structure includes a first controlling unit that moves the holding structure from a first position to the second position, wherein the second position enables capturing at least one image of a planar surface of the log. The first position of the holding structure is a position wherein the holding structure is in a secure position (covered by the walls of the housing structure). Therefore, the at least one imaging device is only exposed to the environment only for capturing at least one image. Thus the at least one imaging device remains protected from the turbulent environment of the forest harvester. Additionally, the arrangement includes first damping component, dampening structure, second damping component that reduces or removes the vibrating effects of the forest harvester. Beneficially, such arrangement enables capturing of appropriate images of the planar surface of the log. Furthermore, the arrangement includes a protective component that firmly supports the housing structure to the head of the forest harvester. Moreover, the arrangement includes a cleaning unit that is operable to clean any obstruction while capturing the image of the planar surface of the log.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of an arrangement for capturing image of a log, in accordance with an embodiment of the present disclosure;

FIG. 2 is a perspective view of the arrangement for capturing image, in accordance with an embodiment of the present disclosure;

FIG. 3 is a perspective view of a head of a forest harvester including the arrangement, in accordance with an embodiment of the present disclosure;

FIG. 4 is a perspective view of the position of the arrangement, in accordance with an embodiment of the present disclosure;

FIGS. 5A-5B, are perspective views of an implementation of the arrangement in accordance with an embodiment of the present disclosure;

FIG. 6 is a perspective view of a head of the forest harvester arranged with plurality of the arrangements, in accordance with an embodiment of the present disclosure; and

FIG. 7 is an illustration are steps of a method of capturing image of a log using an arrangement in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, an embodiment of the present disclosure provides an arrangement for capturing image of a log, the arrangement comprising:
a housing structure comprising at least two end walls and at least one side wall, wherein the at least one side wall include at least one opening;
a holding structure arranged within the housing structure, and wherein the holding structure holds at least one imaging device for capturing at least one image of a planar surface of the log;
a first controlling unit attached to the housing structure and operatively coupled to the holding structure for moving the holding structure from a first position to a second position, wherein at the second position of the holding structure, the at least one imaging device is positioned axially on the at least one opening of the housing structure; and
a second controlling unit operatively coupled to the at least one imaging device, wherein the second controlling unit is configured to instruct the at least one imaging device to capture, after positioning axially, the at least one image of the planar surface of the log.

In a second aspect, an embodiment of the present disclosure provides a method of capturing image of a log using an arrangement, wherein the arrangement includes a housing structure, a holding structure arranged within the housing structure, a first controlling unit attached to the housing structure for moving the holding structure, at least one imaging device, and a second controlling unit for controlling the at least one imaging device, the method comprising:
moving the holding structure from a first position to a second position, wherein at the second position of the holding structure, the at least one imaging device positions axially through an at least one opening of the housing structure; and
capturing the at least one image of a planar surface of the log using the at least one imaging device.

The present disclosure provides the arrangement for capturing image of the log. The arrangement relates to a structure comprising a combination of a plurality of mechanical and/or programmable electronic components, that when operated is configured to perform one or more steps involved in capturing image of the log. Optionally, the arrangement for capturing image of the log is mounted on a head of a forest harvester. Furthermore, the arrangement is mounted on the head of the forest harvester in a manner such that the head of the forest harvester can be maneuvered to capture images (such as orthogonal images) of the planar surface of the log. In an example, the log may be held by an arm of the forest harvester for chopping using a saw or a cutter of the forest harvester. In such an instance, the arrangement coupled to the forest harvester is configured to capture the image of a surface of the log that is generated from chopping the log. Optionally, the surface of the log and the arrangement (i.e. a face of an imaging device including a plurality of lens) form an angle substantially equal to 90°. In such an instance, it will be appreciated that the person operating the forest harvester may include sufficient knowledge for using the forest harvester and the arrangement associated therein.

The arrangement comprises the housing structure comprising at least two end walls and at least one side walls, wherein the at least one side wall include at least one opening. The housing structure refers to a container and/or encapsulation structure that can be used to contain (and/or hold) one or more components of the arrangement. It will be appreciated that, to be housed refers to, but is not limited to, a condition wherein a given component of the arrangement is contained, albeit not necessarily completely, within the housing. Furthermore, the shape and structure of the housing structure is specifically formed to contain and support movement of the one or more components within the housing structure. Specifically, the housing structure includes a cavity therein to contain and support movement of the one or more component. Furthermore, the cavity is formed by the at least two end walls and at least two side walls.

Throughout the present disclosure, the term “wall” relates to a continuous structure that can be used to provide enclosure. Furthermore, the at least two end walls of the housing structure forms a left-hand and right-hand side of the housing structure, and the at least one side wall forms the front side of the housing. Optionally, the housing can include plurality of side walls, namely at least two side walls wherein one of the side walls forms a front side of the housing and the other side wall forms the rear side of the housing structure. It will be appreciated that the side of the housing structure is considered with respect to a position of the log arranged in the forest harvester. Additionally, each of the at least two end walls, and each of the at least two side walls include two ends. Optionally, the housing structure is of rectangular cross-section. The rectangular cross-section forms the encapsulation structure that can be used to contain and/or hold the one or more components of the arrangement. Furthermore, the at least two end walls, and the at least two side walls are arranged in a manner that the cross-section having rectangular shape enclosing a cavity is formed. It will be appreciated that the given end wall and the given side wall are orthogonally coupled therein to form the rectangular cross-section.

Optionally, the at least two end walls and at least two side walls are detachably coupled with each other to form the housing structure. Moreover, the at least two end walls and the at least two side walls can be made of various materials, such as metals, alloy, plastic, rubber and the like. Furthermore, the walls are coupled together using anti-corrosion clay sealant forming a waterproof cavity. Moreover, the materials include materials with only a limited amount of shape altering capability. Optionally, the cavity formed within the housing structure can include one or more forms of structures or engravings that support movement of the one or more components (namely the holding structure) within the housing structure.

Furthermore, the side wall of the at least one side wall includes at least one opening. Throughout the present disclosure, the term “opening” relates to a cut-out that is positioned on the at least one side wall of the housing structure. Furthermore, the opening positioned on the side wall can be of various shape and size that is appropriate for a photographic object of an imaging device for capturing the image of the log. For example, the opening may be circular in shape having an area of 19.63-centimetre squire. Optionally, the opening can have a conical shape, including a plurality of diameter, namely an inner diameter and an outer diameter. For example, the diameter of the opening can be within the range of 3 mm to 12 mm. It will be appreciated that the inner diameter refers to a diameter of a portion of the opening that is closer to the at least one imaging device (explained herein later), subsequently the outer diameter refers to a diameter of a portion of the opening that is distant from the at least one imaging device as compared to the portion wherein the inner diameter is calculated for the opening. Furthermore, the diameter of the opening can vary based on the type of lens (namely autofocused or manual) used in the at least one imaging device. In an example, the side wall including the opening may have a thickness is 3 mm, in such instance, the opening may have an inner diameter of 3.4 mm and an outer diameter of 8.26 mm, in the event wherein the type of lens used in the at least one imaging device is an autofocused lens having a diameter of 2 mm. In another example, the side wall including the opening may have a thickness is 3 mm, in such instance, the opening may have an inner diameter of 6.4 mm and an outer diameter of 11.26 mm, in the event wherein the type of lens used in the at least one imaging device is a manually focused lens having a diameter of 2 mm. Beneficially, a smaller opening in the arrangement includes a lesser risk for objects to hit the lens and easier to keep the arrangement clean.

Furthermore, the at least one side wall forming the front portion of the housing structure include the at least one opening. Optionally, the side wall forming the front portion of the housing structure can include two openings, wherein one of the two openings is used for capturing image of the log, and the other opening is used for transmitting light (flash light) on the log.

The arrangement further comprises a transparent component snugly arranged on the at least one opening of the housing structure for covering the at least one opening. Optionally, the transparent component relates to a transparent covering structure that is pivotally arranged over the at least one opening of the housing structure. Optionally, the transparent component is slidably arranged over the at least one opening of the housing structure. Optionally, the transparent component is arranged in a manner that the transparent component fits onto the at least one opening of the housing structure. Furthermore, the transparent component can be arranged on the housing structure using various means. Examples of the various means may include, magnetic coupling unit, snap fit coupling unit, coupling using a screw and nut, hinge, pivot, and the like. Optionally, the transparent component is arranged in a manner that obstructs the passage of external elements, such as water, dirt, soil, tree branches and the like. Additionally, the transparent component may be composed of protective glass or plastic material, such as polyethylene terephthalate. Furthermore, the transparent component is positioned in front of the photographic objective (such as a plurality of lenses) of at least one imaging device. It will be appreciated that, snugly arranging the protective component refers to arranging the protective component in a manner that the protective component obstructs entry of any element through the at least one opening of the housing structure.

In one embodiment, the transparent component can be protective housing arranged around the at least one opening of the housing structure. Optionally, the transparent component can include a plurality of sections which forms a chamber for housing the at least one imaging device. Optionally, the plurality of sections of the protective housing are detachably coupled to each other to form a cavity for accommodating the at least one imaging device therein.

The arrangement comprises the holding structure arranged within the housing structure, and wherein the holding structure holds at least one imaging device for capturing at least one image of the planar surface of the log. Throughout the present disclosure, the term “holding structure”” relates to a holding arrangement wherein the at least one imaging device can be securely fit onto. Furthermore, the holding arrangement can be a bracket that can include two or more arms, wherein the arms can include mounting arrangement where the at least one imaging device securely fits onto the arms. Moreover, the holding structure can be made of various materials, such as metals, alloy, plastic, rubber and the like. Furthermore, the materials include materials with only a limited amount of shape altering capability. Optionally, the holding structure is arranged within the cavity formed within the housing structure. Furthermore, the holding structure can be arranged on the one or more structures or engravings that are formed on the walls of the housing structure that support movement therein. Furthermore, the holding structure can include any shape or size that is appropriate to be arranged within the housing structure and holding the camera. Furthermore, the holding structure is detachably arranged within the housing structure.

Throughout the present disclosure, the term “at least one imaging device” relates to a device that includes at least one lens and image sensor to acquire a reflectance from a reflected visible light that is reflected from the planar surface of the log. Optionally, the at least one imaging device includes a body housing an electronic circuit, a photographic objective mounted on the body for capturing the at least one image, a peripheral device (such as Universal Serial Bus device) operatively coupled to the electronic circuit for establishing data communication, and a storage unit (such as a memory) for storing the at least one image captured by the photographic objective. In an example, the at least one imaging device is implemented using a uEye LE USB 3.1 Gen. 1 camera. Optionally, the at least one imaging device comprises a high-resolution digital camera. Optionally, “high resolution” relates to more than 1000 pixels in X- and Y-Cartesian axes of a given captured digital image, more optionally more than 2000 pixels in X- and Y-Cartesian axes of a given captured digital image. It will be appreciated that, the image captured by the at least one image captured by the at least one imaging device refers to a digital image having a series of pixels that represent an image of the planar surface of the log, and is capable of being stored in and retrieved from storage unit of the at least one imaging device.

Furthermore, the planar surface is a side of the log. The planar surface can be any other substantially-flat surface of the log that is required to be uniquely identified. For example, the planar surface can be a front (or rear, top, bottom, left-side, right-side) surface of the log whose image is to be captured by the at least one imaging device.

Optionally, the at least one imaging device is mounted on the head of the forest harvester. The at least one imaging device is mounted on the head of the forest harvester in a manner such that the imaging device is capable of capturing a side view of the log. Optionally, the at least one imaging device is mounted inside of a protective housing to prevent contact of the chain saw with the imaging device that may result in damage thereof. Optionally, the at least one imaging device is rigidly mounted on the holding structure. For example, the at least one imaging device may be welded into the holding structure. In another example, the at least one imaging device is detachably coupled using a screw onto the holding structure.

Furthermore, the at least one imaging device is mounted retractably using a retractable mechanism that allows maneuvering of the at least one imaging device for capturing the image of the planar surface of the log. In such an example, the at least one imaging device can be arranged near an assembly line, wherein the at least one imaging device is arranged substantially perpendicular to the planar surface of the log and wherein each of the at least one imaging device is operable to capture the image of the planar surface of the log from a different position (or angle).

Optionally, the at least one imaging device comprises a plurality of lenses. The plurality of lenses included in at least one imaging device forms a lens assembly that can be iteratively arranged for capturing the at least one image of the planar surface of the log. The plurality of lenses is arranged within a photographic objective of the at least one imaging device. It will be appreciated that the photographic objective expands or retracts for capturing the at least one image of the planar surface of the log. Furthermore, the plurality of lenses can include various types of lens units, such as a zoom lens unit, a drive unit and the like. It will be appreciated that the lens units include lenses that are arranged statically and/or moveably for capturing the at least one image of the planar surface of the log.

Optionally, the at least one imaging device can include a motion sensor arrangement operatively coupled to the plurality of lenses that can be configured using one or more programming code (stored in the storage unit of the at least one imaging device) to automatically adjust the position of the plurality of lenses. Optionally, the motion sensor arrangement is preferably located within the plurality of lenses. Furthermore, the motion sensor arrangement can include angular rotation sensors configured to detect and store readings related to angular rotation about the orthogonal axis of rotation of the plurality of lenses; and linear acceleration sensors configured to detect and store reading related to linear acceleration in orthogonal directions of the plurality of lenses. It will be appreciated that the motion sensor arrangement is operable to detect and store the angular rotation and linear acceleration of the plurality of lenses when manually positioned.

Optionally, the plurality of lenses is autofocused to capture the at least one image of the planar surface of the log. Optionally, the at least one imaging device can include a lens controller circuitry coupled to the plurality of lenses for autofocusing the plurality of lenses. Furthermore, the lens controller circuitry comprises one or more programmable and non-program able components for arranging the position of the plurality of lenses to achieve autofocus. Moreover, the one or more programmable components of the lens controller circuitry can host one or more computer programs or routines that is configured to arrange the position of the plurality of lenses using the one or more non-programmable components. Furthermore, the position of the plurality of lenses is automatically arranged based on optical inputs (incoming light) received from the planar surface of the log.

Optionally, the plurality of lenses is manually focused for capturing the at least one image of the planar surface of the log. Optionally, the plurality of lenses can be focused by action requiring human intervention. In an example, the person operating the forest harvester may have sufficient knowledge of manually focusing the plurality of lenses in the at least one imaging device for capturing the at least one image of the planar surface of the log.

Optionally the arrangement further comprises a first damping component arranged between the holding structure, and the at least one imaging device. The first damping component refers to an object or an item arranged between the holding structure, and the at least one imaging device. Furthermore, the first damping component includes, but is not limited to, devices that counteract, control or reduce the vibrations of a vibrating element but also devices such as isolators that insulate or protect elements that are associated with a vibrating element, such as the head of the forest harvester. In an example, the first damping component can be a rubber mat that is coupled to the holding structure.

Optionally the arrangement further comprises a dampening structure on the at least one opening of the housing structure. The dampening structure refers to grooves or cuts on the housing structure that securely holds the holding structure in the housing structure. Optionally, the dampening structure can be formed within the at least one opening of the housing structure that enables secure holding of the at least one imaging device. For example, in the event wherein photographic objective of the at least one imaging device is positioned out from the body of the at least one imaging device; the dampening structure securely holds the photographic objective and dampens the vibration occurring in the head of the forest harvester while in operation.

The arrangement comprises the first controlling unit attached to the housing structure and operatively coupled to the holding structure for moving the holding structure from the first position to the second position. The first controlling unit refers to assembly of one or more components that is operable to move the holding structure within the housing structure from one position to another, namely from the first position to the second position. In an example, a first controlling unit may be a solenoid assembly that includes plurality of components such as a magnetic coil, a magnetic pole piece, an operating rod, and a magnetic arm. In such an example, the magnetic pole piece may be coupled to the housing structure, the magnetic pole piece connects the magnetic coil and the operating rod, and the operating rod connects the magnetic arm. Furthermore, the housing structure, the magnetic coil, the magnetic pole piece, the operating rod, and the magnetic arm are connected using welding process, magnetic coupling unit, a screw and nut, hinge, pivot, and the like. Furthermore, the plurality of components of the solenoid assembly operate in a manner to change the position and/or an angular orientation of the holding structure to an appropriate position such that the at least one imaging device included in the holding structure is capable of capturing at least one image of the planar surface of the log. In another example, the first controlling unit is an actuator assembly attached to the housing structure and operatively coupled to the holding structure. In such an example, the actuator assembly comprises at least one of a hydraulic or a pneumatic actuator that is operable to change a position and/or an angular orientation of the holding structure within the housing structure. Furthermore, in such example the actuator assembly is operatively coupled to the holding structure via a piston-cylinder assembly, wherein the cylinder is mechanically coupled with the actuator assembly and the piston is mechanically coupled with the holding structure. Furthermore, the actuator assembly is implemented as a hydraulic actuator, wherein cylinder comprises a fluid that is operable to be compressed (or expanded) to change a position of the piston with respect to the cylinder. In such an instance, expansion of the fluid within the cylinder is operable to modify the position of the holding structure. For example, expansion of the fluid within the cylinder is operable to push the holding structure within the housing structure that is movably coupled therein. Alternatively, the actuator assembly is operable to change the angular orientation of the holding structure, such as, by rotating the holding structure with respect to an initial angular orientation thereof, within the housing structure.

The first position of the holding structure refers to a location of the holding structure within the housing structure. Moreover, the first position refers to the location of the holding structure within the housing structure wherein the at least one imaging device is positioned in a manner that the photographic objective of the at least one imaging device is not facing the at least one opening in the housing structure. Furthermore, at the second position of the holding structure, the at least one imaging device is positioned axially on the at least one opening of the housing structure. Moreover, positioning the at least one imaging device axially with the at least one opening of the housing structure, refers to location of the at least one imaging device wherein the photographic objective of the at least one imaging device is facing the at least one opening in the housing structure. It will be appreciated that, positioned axially refers to the at least one imaging device and the at least one opening of the housing structure aligned in a manner that both the at least one imaging device and the at least one opening are aligned on an axis of abscissas.

Furthermore, positioning the at least one imaging device axially with the at least one opening of the housing structure, the at least one imaging device is operable to capture the at least one image at an orthogonal angle, namely not at an oblique angle to an elongate axis of the log or the surface of the log that is being imaged. The second position of the holding structure arranges the at least one imaging device to be held perpendicularly (orthogonally) for taking orthogonal images of the planar surface of the object, such as the side of the log. Optionally, a value of the orthogonal angle that is formed while capturing the at least one image is dependent on a distance between the imaging device and the planar surface of the object. Optionally, the value of the orthogonal angle is inversely proportional to the distance between the at least one imaging device and the planar surface of the object, i.e. for a smaller distance between the at least one imaging device and the log in the arrangement, the orthogonal angle formed while capturing the at least one image is greater as compared to the orthogonal angle formed while capturing the at least one image wherein the distance between the at least one imaging device and the log is greater. Optionally, the at least one imaging device is operable to capture image of the side of the object, when held orthogonally with respect to the at least one imaging device coupled to the forest harvester. In an example, the log may be held by an arm of the forest harvester for chopping. In such an instance, the at least one imaging device coupled to the forest harvester is configured to capture an image of the surface of the log that is substantially perpendicular to the at least one imaging device. It is to be understood that the surface of the log and the at least one imaging device (i.e. a face 10 of imaging device including a lens assembly) form an angle substantially equal to 90°.

The arrangement comprises the second controlling unit operatively coupled to the at least one imaging device. The second controlling unit refers to structure and/or module including programmable and/or non-programmable components that are configured to execute one or more software application for storing, processing and/or sharing data and/or set of instruction. Optionally, the second controlling unit can be arranged within the holding structure or the forest harvester. Optionally, the second controlling unit includes a communication module that is operable to transmit signals for controlling the operation of the at least one imaging device. Optionally, the communication module provides a wired or wireless interface between the second controlling unit and the at least one imaging device. In an example, the communication module may include a fiber optic assembly for providing the interface between the second controlling unit and the imaging device. In another example, the wireless interface between the second controlling unit and the at least one imaging device includes, but is not limited to a Low-Power Wide-Area Network (LPWAN) or other wireless area network technology, such as wireless personal area network technology. In such example, wireless personal area network technology may include INSTEON®, IrDA®, Wireless USB®, Bluetooth®, Bluetooth Low Energy (BLE), Z-Wave®, ZigBee®, Body Area Network and so forth. Optionally, the second controlling unit is further operable to transmit a signal to the at least one actuator assembly to modify the position of the at least one imaging device. The signals transmitted by the second controlling unit may include data communication for the at least one actuator for moving the position of the at least one imaging device to capture images of the planar surface. It will be appreciated that the at least one actuator assembly includes a control unit that is configured to receive the signals transmitted by the second controlling unit and subsequently control the operation of the at least one actuator assembly. Optionally, the second controlling unit is further operable to transmit signals for facilitating various other operations such as controlling image capturing functionality, maneuvering the at least one imaging device, firmware upgrade of the at least one imaging device, complete configuration and reconfiguration of the at least one imaging device and so forth. Optionally, the second controlling unit is implemented as a carputer arranged within the forest harvester.

The second controlling unit is configured to instruct the at least one imaging device to capture, after positioning axially, the at least one image of the planar surface of the log. The one or more software application included in the second controlling unit is configured to determine if the at least one imaging device is positioning axially, on the planar surface of the log. In an example, the one or more software application determines that at least one imaging device is positioning axially on the planar surface of the log based on the optical inputs (incoming light) from the planar surface. Furthermore, upon determining that the at least one imaging device is axially positioned on the planar surface of the log, the one or more software application can use the communication module to transmit signals instructing the at least one imaging device to capture the at least one image of the planar surface of the log. In such an instance, the lens controller circuitry of the at least one imaging device can arrange the plurality of lenses in a manner that photographic objective aligns with the at least one opening of the housing structure to capture the image of the planar surface of the log.

Optionally, the at least one image of the planar surface of the log is a high dynamic range (HDR) image. Optionally, the at least one image captured by the at least one imaging device can be reproduced to increase the dynamic range of luminosity therein, and consequently generate the high dynamic range (HDR) image of the planar surface of the log. Optionally, the at least one image can be transmitted to the data processing apparatus operatively coupled to the at least one imaging device for generating the high dynamic range (HDR) image of the planar surface of the log. In an example, the at least one imaging device can capture multiple images of the log cut in the planar surface of the log, as the log cut includes shadows as the cut has an uneven surface on the planar surface of the log. In such an instance the at least one imaging device can capture an overexposed, a normal exposed and an underexposed image of the planar surface of the log and transmit the images to the data processing apparatus. Subsequently, the data processing apparatus processes the images to generate the high dynamic range (HDR) image of the planar surface of the log.

Optionally the arrangement further comprises a protective component snugly arranged on the housing structure for providing support therein. The protective component is a structure that is arranged on the housing structure in a manner that provides support by firmly coupling the housing structure to the head of the forest harvester. In an example, the protective component may be a U-shaped metallic bracket that is snugly coupled to the housing structure and couples the arrangement to the head of the forest harvester. Furthermore, the protective component is a structure that is constructed and positioned on the head of the forest harvester in a manner that the protective component obstructs strikes from branches, stones, or similar items, while the head of the forest harvester is in operation.

Optionally, the protective component includes at least one opening coaxial to the at least one opening of the housing structure. The at least one opening in the protective component is dimensionally similar to the at least one opening of the side wall of the housing structure. Furthermore, the at least one opening in the protective component is so positioned on the protective component that the at least one opening of the housing structure and at least one opening in the protective component align along a common axis. Optionally, the at least one opening of the housing structure is concentric to the at least one opening in the protective component.

Optionally, the arrangement further comprises a second damping component arranged between the protective component and the housing structure. Optionally, the second damping component is similar to the first damping component. For example, the second damping component refers to devices that counteract, control or reduce the vibrations of a vibrating element but also devices such as isolators that insulate or protect elements that are associated with a vibrating element, such as the head of the forest harvester. Furthermore, the second damping component can be a rubber mat that is arranged between the protective component and the housing structure.

Optionally, the arrangement further comprises a cleaning unit for cleaning the at least one imaging device. The cleaning unit is an assembly of plurality of components that is configured to remove any kind of element forming on the transparent component snugly arranged on the at least one opening of the housing structure. Examples of the element may include, water, soil, saw-dust, branch of tree, and the like. Optionally, the plurality of components of the cleaning unit can include programmable and/or non-programmable components. Examples of programmable components may include sensors, electronic actuators, robotic arms, automatic sprayer and the like. Examples of non-programmable components may include manual wiper, slidable layer and the like. Optionally, cleaning unit can be high speed air blower arranged on the head of the forest harvester.

Optionally, the cleaning unit is configured to spray on the at least one imaging device, at least one of: compressed air, and cleaning liquid. Optionally, the cleaning unit includes at least one automatic sprayer that is configured to spray cleaning elements on a surface of the transparent component snugly arranged on the at least one opening. Optionally, the at least one automatic sprayer may be nano-spray. Optionally, the at least one imaging device can include a sensor (such as optical sensor) that is configured to trigger the at least one automatic sprayer to spray cleaning elements upon detecting any kind of obstruction on the transparent component. In an example, the at least one automatic sprayer may be configured to spray compressed cleaning gaseous elements on the transparent component. In another example, the automatic sprayer can spray a compressed air. In yet another example, the at least one automatic sprayer may be configured to spray cleaning liquid in the form of aerosol that may evaporate upon cleaning the surface of the transparent component.

Optionally, the cleaning unit is configured to spray compressed air, and cleaning liquid on an external surface of the transparent component and on the internal surface of the transparent component. It will be appreciated that, the external surface of the transparent component refers to the surface facing the environment of the head of the forest harvester, and internal surface of the transparent component that is the opposite side of the external surface facing the at least one imaging device.

Optionally, cleaning unit can include two automatic sprayers for spraying different elements on different surfaces of the transparent component. For example, one automatic sprayer may spray water at a high speed on the external surface of the transparent component, and another automatic sprayer may spray air at a high speed on the internal surface of the transparent component. Optionally, the cleaning unit can be cleaning brush that is arranged inside the transparent component snugly arranged on the at least one opening, for cleaning the photographic objective while expanding or retracting for capturing the at least one image of the planar surface of the log.

Optionally, the cleaning unit is a self-cleaning micro filter. Optionally, the self-cleaning micro filter can be arranged pivotally on the at least one opening of the housing structure. The self-cleaning micro filter is arranged in a manner that the photographic objective pushes while expanding for capturing the at least one image and rests on the photographic objective, and subsequently as the photographic objective retracts, the self-cleaning micro filter covers the at least one opening of the housing structure.

Optionally, the arrangement further comprises a power source connected to the at least one imaging device, the first controlling unit and the second controlling unit, for providing operational power thereto. The power source refers to the power source of the forest harvester. In an example, the power source can be a power source used for operating the forest harvester. In another example, the power source can be the battery that powers the forest harvester. In another example, the power source can be an individual power source coupled to the arrangement, such as a battery or a solar power battery.

Optionally, the arrangement can include a cooling unit that is coupled to the at least one imaging device. Furthermore, the cooling unit is operable to use one or more means for cooling the temperature of the at least one imaging device. Example of means for cooling the temperature of the at least one imaging device includes disposing coolant around the at least one imaging device. Furthermore, the cooling unit can be configured to dispose coolant around the at least one imaging device at regular intervals.

In an embodiment, the arrangement can have tubular structure and/or a rectangular structure. In one instance wherein, the arrangement is of tubular structure, the holding structure arranged within the housing structure in a manner that the holding structure can rotate within the housing structure. In such instance, the first position of the holding structure is a position wherein the at least one imaging device is covered by the housing structure, and the second position of the holding structure is a position wherein a centre of the lenses of the at least one imaging device and a center of the opening is positioned on a single axis. Furthermore, it will be appreciated that, in such instance the first controlling unit rotates the holding structure from the first position to the second position (and vice a versa) within the housing structure.

In another instance wherein, the arrangement is of rectangular structure, the holding structure arranged within the housing structure in a manner that the holding structure can slide within the housing structure. In such instance, the first position of the holding structure is a position wherein the at least one imaging device is covered by the housing structure, and the second position of the holding structure is a position wherein a centre of the lenses of the at least one imaging device and a center of the opening is positioned on a single axis. Furthermore, it will be appreciated that, in such instance the first controlling unit slides the holding structure from the first position to the second position (and vice a versa) within the housing structure.

Furthermore, in such embodiment, the arrangement can include at least two imaging devices for capturing the at least one image of a planar surface of the log. In such embodiment, the housing structure includes at least two opening for the at least two imaging devices, and an additional opening for the for enabling immersion of light from a light source (such as, a flash light). Optionally, the at least two opening for the at least two imaging devices can be formed on the circumferential region of the arrangement having a tubular structure. Furthermore, in such instance, the housing structure rotates the holding structure including the at least two imaging devices, in a manner that the at least two imaging devices are capable of capturing images of the planar surface of the log. Moreover, in such embodiment, the one of the imaging device of at least two imaging devices can include autofocus lenses, and the other imaging device of at least two imaging devices can include manually focus lenses. Alternatively, both of the at least two imaging devices can include autofocus lenses, or both of the at least two imaging devices can include manually focus lenses.

Optionally one of the lenses is an infrared (IR) lens. By capturing an image of the log with the IR lens it will be possible to determine the type of tree.

Optionally the arrangement can be provided with an optical fiber, which one end is arranged at the opening in the arrangement and other end is connected to the imaging device. In this embodiment the imaging device can be arranged away from the housing structure somewhere on the harvester.

In such instance, the first controlling unit is operable to position the holding structure including at least two imaging devices in position that the both the imaging devices faces the at least two opening in the housing structure. In such as instance wherein, both the imaging devices captures the images of a planar surface of the log and transmits the images of a planar surface of the log to the second controlling unit. Furthermore, the second controlling unit can include one or more algorithms to analyse the transmitted images of the planar surface of the log, and subsequently merge the transmitted images to generate the high dynamic range (HDR) image of the planar surface of the log.

### DETAILED DESCRIPTION OF THE DRAWINGS

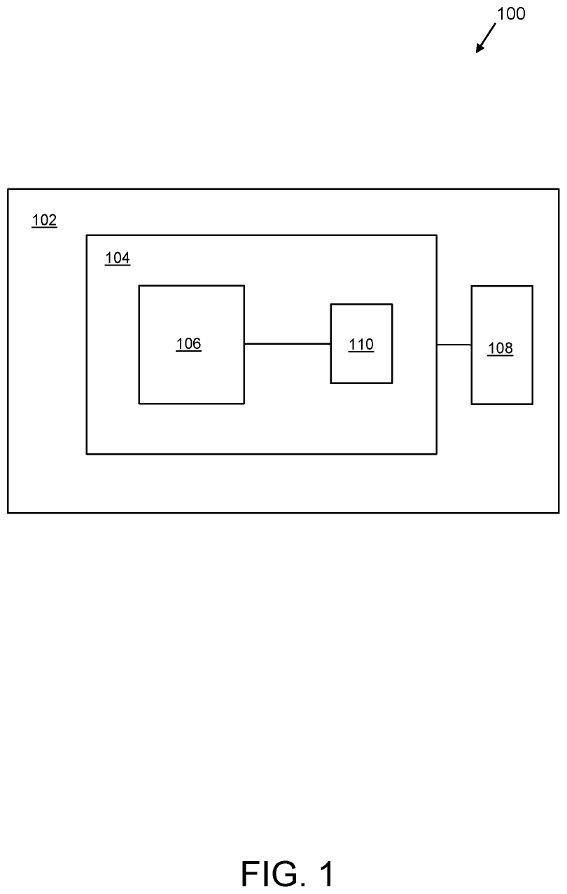

Referring to FIG. 1, there is shown a block diagram of an arrangement 100 for capturing image of a log, in accordance with an embodiment of the present disclosure. As shown, the arrangement 100, includes a housing structure 102, a holding structure 104, at least one imaging device 106, a first controlling unit 108, and a second controlling unit 110.

Furthermore, as shown the holding structure 104 is arranged within the housing structure 102, and the at least one imaging device 106 arranged within the holding structure 104. Additionally, the first controlling unit 108 is arranged within the housing structure 102 and the second controlling unit 110 is arranged within the holding structure 104. Moreover, the second controlling unit 108 is operatively coupled to the at least one imaging device 106.

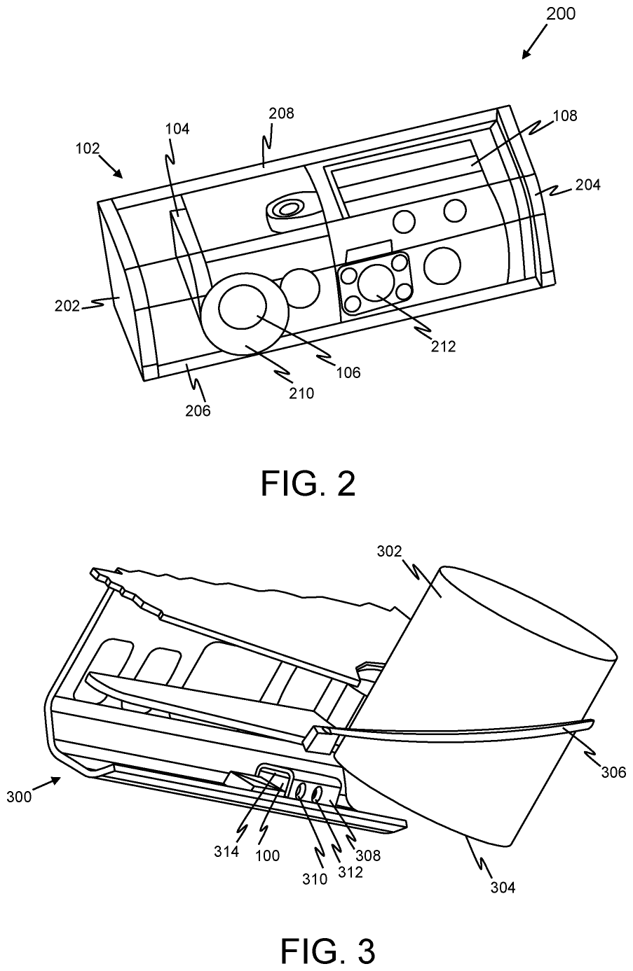

Referring to FIG. 2, there is shown a perspective view of the arrangement 200 for capturing image, in accordance with an embodiment of the present disclosure. As shown, the arrangement 200, includes the housing structure 102 includes the end walls 202 and 204 forms the left-hand and right-hand side of the housing structure 102 respectively. Furthermore, the side walls 206 and 208 forms the front and the rear sides of the housing structure 102 respectively. Additionally, the side walls 206 includes at least one opening 210 for enabling the at least one imaging device 106 to capture the at least one image. Furthermore, the housing structure 102 include additional opening 212 for enabling immersion of light from a light source (such as, a flash light). Moreover, the at least one imaging device 106 is arranged within the holding structure 104. Furthermore, the arrangement 200 includes the first controlling unit 108 that is attached to the housing structure 102 and operatively coupled to the holding structure 104. Furthermore, the arrangement 200 shows a position (the second position) of the holding structure 104, wherein the at least one imaging device 106 is arranged in a position that the at least one imaging device 106 is capable of capturing the at least one image.

Optionally, the at least one imaging device 106 may include miniature camera having a manual focusing lenses use M12×0.5 mm or with S lens. Moreover, the difference between two equivalent lenses of plurality of lens included in the at least one imaging device 106 may have a diagonal angle 78°. Furthermore, the manually focusing the lens in the plurality of lens may have an aperture of about 12 mm. Additionally, the at least one imaging device 106 with manual focus may have an opening of 12 mm, wide angle 78° and plate thickness 3 mm. Furthermore, the at least one imaging device 106 may include autofocusing lens having an opening of about 3.4 mm. Optionally the at least one imaging device 106 autofocusing lens may have a lens diameter of 2 mm requires only an opening in the camera house of to 3.4 mm inside and 8.26 mm outside when the wall thickness of the camera body may be 3 mm. Optionally, the arrangement 200 includes first damping component arranged between the holding structure 104 and the at least one imaging device 106, and a dampening structure on the at least one opening 210 of the housing structure 102.

Referring to FIG. 3, there is shown a perspective view of a head 300 of a forest harvester including the arrangement 100 for capturing image of a planner portion 304 of the log 302, in accordance with an embodiment of the present disclosure. As shown the head 300 of the forest harvester that includes an arm 306 that holds the log 302 for cutting/chopping.

Furthermore, the arrangement 200 is shown to be coupled to the head 300 of the forest harvester. Additionally, a protective component 308 is so arranged that, the protective component 308 holds and supports arrangement 100 to the housing structure 102 (not shown). Furthermore, the protective component 308 include two openings 310 and 312 that are coaxial to the at least one opening 210 and the additional opening 212 (not shown). Additionally, second damping component 314 is arranged between the protective component 308 and the housing structure 102 (not shown).

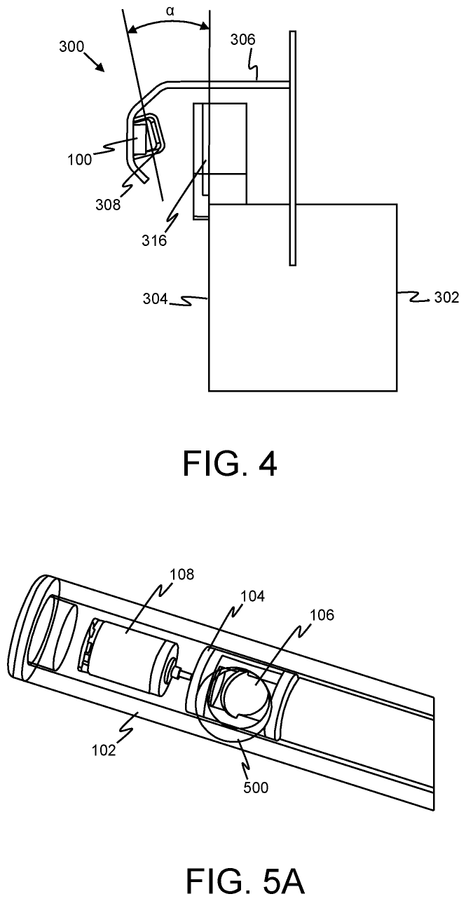

Referring to FIG. 4, there is shown a perspective view of the position of the arrangement 100 on the head 300 of the forest harvester for capturing image of the planner portion 304 of the log 302, in accordance with an embodiment of the present disclosure. As shown, the arrangement 100 is arranged on the head 300 of the forest harvester using the protective component 308 such that the at least one imaging device 106 (not shown) is substantially perpendicular to the planner portion 304 of the log 302 head by the arm 306 of the forest harvester. Furthermore, shown is a side view of the at least one imaging device 106 position relative a sword 316 on the head 300 of the forest harvester. Optionally a may be an angle between a longitudinal axis of the at least one imaging device 106, and the planner portion 304 of the log 302. In such instance, the angle (value of a) may be approximately 15°.

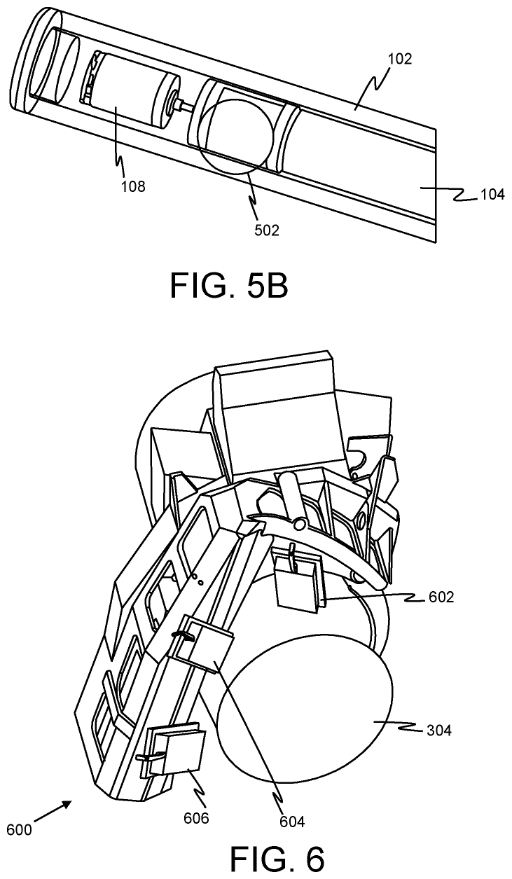

Referring to FIGS. 5A and 5B, there is shown a perspective views of an implementation of the arrangement 100, in accordance with an embodiment of the present disclosure. As shown, the arrangement 100 includes the housing structure 102, a holding structure 104, at least one imaging device 106, a first controlling unit 108, and the at least one opening 210. The arrangement 100 in a tubular shape, wherein the at least one opening 210 is covered by the protective component 308 that covers the at least one opening 210. Specifically, the FIG. 5A describes an instance 500 wherein the at least one opening 210 is not covered by the protective component 308. Furthermore, the FIG. 5B describes an instance 502 wherein the at least one opening 210 is covered by the protective component 308.

Referring to FIG. 6, there is shown a perspective view of a head 600 of the forest harvester arranged with plurality of the arrangements, in accordance with an embodiment of the present disclosure. As shown the plurality of the arrangement 602, 604, and 606. Furthermore, the plurality of the arrangement 602, 604, and 606 is mounted on the head 600 of the forest harvester at different positions. Beneficially, mounting the plurality of the arrangement 602, 604, and 606 on the forest harvester at different positions enables the capturing image from different perspective, that can be processed by a data processing apparatus for generating the image of the planner portion 304 of the log 302. It will be appreciated that the head 600 of the forest harvester is similar to the head 300 of a forest harvester, and the arrangement 602, 604, and 606 is similar to the arrangement 100.

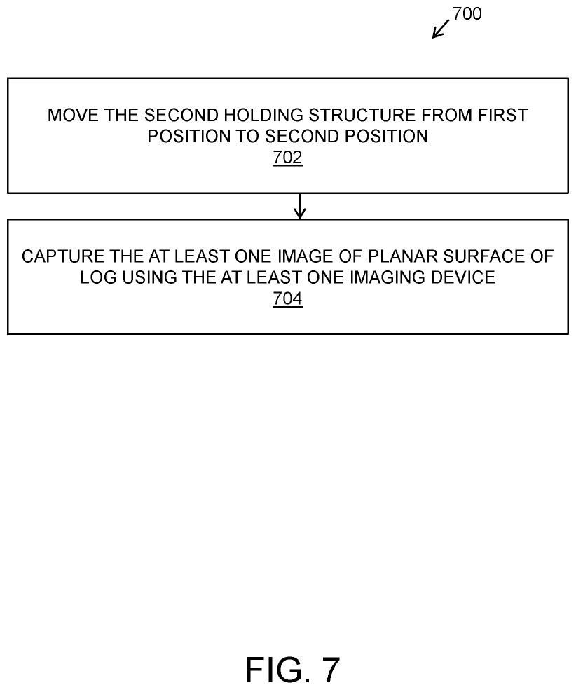

Referring to FIG. 7, illustrated are steps of a method 700 of capturing image of a log using an arrangement in accordance with an embodiment of the present disclosure. At a step 702, the holding structure is moved from a first position to a second position, wherein at the second position of the holding structure, the at least one imaging device positions axially through an at least one opening of the housing structure. At a step 704 the at least one image of a planar surface of the log is captured using the at least one imaging device.

The steps 702 to 704 are only illustrative and other alternatives can also be provided where one or more steps are added, one or more steps are removed, or one or more steps are provided in a different sequence without departing from the scope of the claims herein. For example, the method further comprises dampening of vibrations in the arrangement.

In an example, the method further comprises snugly arranging a transparent component on the at least one opening of the housing structure for covering the at least one opening therein. In another example, the method further comprises providing operational power to the at least one imaging device, the first controlling unit and the second controlling unit. In one example, the method further comprises cleaning the at least one imaging device using a cleaning unit. In another example, the method, the cleaning of the at least one imaging device comprises spraying compressed air and/or cleaning liquid thereon. In yet another example, the method, the method further comprises autofocusing the at least one imaging device to capture the at least one image of the planar surface of the log, or manually focusing the at least one imaging device for capturing the at least one image of the planar surface of the log. In another example, the method further comprises capturing a high dynamic range (HDR) image of the at least one image of the planar surface of the log.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1-22. (canceled)

23. An arrangement for capturing image of a log, the arrangement comprising:
a housing structure comprising at least two end walls and at least one side walls, wherein the side wall includes at least one opening;
a holding structure arranged within the housing structure, and wherein the holding structure holds at least one imaging device for capturing at least one image of a planar surface of the log;
a first controlling unit attached to the housing structure and operatively coupled to the holding structure for moving the holding structure from a first position to a second position, wherein at the second position of the holding structure, the at least one imaging device is positioned on an axis of abscissas of the at least one opening of the housing structure; and
a second controlling unit operatively coupled to the at least one imaging device, wherein the second controlling unit is configured to instruct the at least one imaging device to capture the at least one image of the planar surface of the log.

24. An arrangement of claim 23, wherein the arrangement further comprises, at least one of:
a first damping component arranged between the holding structure and the at least one imaging device, and
a dampening structure on the at least one opening of the housing structure.

25. An arrangement of claim 23, wherein the arrangement further comprises a transparent component snugly arranged on the at least one opening of the housing structure for covering the at least one opening.

26. An arrangement of claim 23, wherein the arrangement further comprises a protective component snugly arranged on the housing structure for providing support therein.

27. An arrangement of claim 27, wherein the protective component includes at least one opening coaxial to the at least one opening of the housing structure.

28. An arrangement of claim 23, wherein the arrangement further comprises a second damping component arranged between the protective component and the housing structure.

29. An arrangement of claim 23, wherein the arrangement further comprises a cleaning unit for cleaning the at least one imaging device.

30. An arrangement of claim 29, wherein the cleaning unit is configured to spray on the at least one imaging device, at least one of: compressed air, and cleaning liquid.

31. An arrangement of claim 29, wherein the cleaning unit is a self-cleaning micro filter.

32. An arrangement of claim 23, wherein the at least one imaging device comprises a plurality of lenses.

33. An arrangement of claim 32, wherein the plurality of lenses is:
autofocused to capture the at least one image of the planar surface of the log; or
manually focused for capturing the at least one image of the planar surface of the log.

34. An arrangement of claim 23, wherein the at least one image of the planar surface of the log is a high dynamic range (HDR) image.

35. An arrangement of claim 23, wherein the housing structure is of rectangular cross-section.

36. A method of capturing image of a log using an arrangement, wherein the arrangement includes a housing structure, a holding structure arranged within the housing structure, a first controlling unit attached to the housing structure for moving the holding structure, at least one imaging device, and a second controlling unit for controlling the at least one imaging device, the method comprising:
moving the holding structure from a first position to a second position, wherein at the second position of the holding structure, the at least one imaging device positions on an axis of abscissas of an at least one opening of the housing structure; and—capturing the at least one image of a planar surface of the log using the at least one imaging device.

37. A method of claim 36, wherein the method further comprises dampening of vibrations in the arrangement.

38. A method of claim 36, wherein the method further comprises snugly arranging a transparent component on the at least one opening of the housing structure for covering the at least one opening therein.

39. A method of claim 36, wherein the method further comprises cleaning the at least one imaging device using a cleaning unit.

40. A method of claim 39, wherein the cleaning of the at least one imaging device comprises spraying compressed air and/or cleaning liquid thereon.

41. A method of claim 36, wherein the method further comprises:
autofocusing the at least one imaging device to capture the at least one image of the planar surface of the log; or
manually focusing the at least one imaging device for capturing the at least one image of the planar surface of the log.

42. A method of claim 36, wherein the method further comprises capturing a high dynamic range (HDR) image of the at least one image of the planar surface of the log.
